(19) United States
(12) Patent Application Publication
(10) Pub. No.: US 2012/0061490 A1
(43) Pub. Date: Mar. 15, 2012

(54) HAND HELD SPRAY VALVE

(76) Inventor: William Yiu Man Chung, Hong Kong (HK)

(21) Appl. No.: 12/881,506

(22) Filed: Sep. 14, 2010

(51) Int. Cl. B05B 9/01

(52) U.S. Cl. 239/526

(57) ABSTRACT

A hand held spray valve assembly includes a trigger upon which a linear force is applied to cause the assembly to switch from the normally closed condition to the open condition. The trigger includes a slider element having a tapered end which is in contact with and opposes a complimentarily tapered end of a moveable piston. By applying a force on the trigger, the tapered end of the slider element moves linearly over the tapered end of the piston and creates a force upon the piston. The force on the piston causes the piston to move to a position where a sealing element in the assembly does not obstruct a waterway channel through which water under pressure can flow from an inlet, through the waterway channel and out a spray face of the assembly.

### FIELD OF THE INVENTION

The present invention relates generally to fluid valves and, more particularly, to a hand held spray valve for a kitchen sink and the like.

### BACKGROUND OF THE INVENTION

Hand held spray valves for kitchen sinks and the like are well known. Typically, a hand held spray valve assembly is attached to a flexible hose extending from a faucet valve, and is mounted so that it can be pulled away from the rim of a kitchen sink. The spray valve assembly is normally in the closed condition, where fluid does not spray. When a spray of fluid from the assembly is desired, an operator pulls the assembly away from the sink and manually manipulates a component, such as a handle, of the assembly, which permits water to be released from the assembly as a spray.

Prior art spray valve assemblies are prone to leak at some time after installation, following continual use. In additional, the construction of prior art spray valve assemblies requires an operator to apply a substantial force to the handle, in order to have fluid spray from the assembly. As the operator usually operates the valve assembly with one hand while the other hand holds another utensil or item, the operator oftentimes has difficulty operating the valve assembly to cause a spray.

What is needed is a hand held spray valve constructed for ease of operation and that does not leak following continued use.

In accordance with the present invention, a spray valve assembly includes a housing having a handle portion and a spray head portion. The handle portion includes a moveable element, such as a piston, and a sealing element, such as an O-ring. The moveable element extends between an inlet and an end terminating within the spray head portion. The moveable element moves toward the inlet when a force in the direction of the inlet is applied at the end. The spray head portion includes a trigger element on one end and a spray head on an opposing end. The trigger element includes a projection extending toward the spray head and terminating in a tapered end. The tapered end is positioned to contact and oppose end surface of the end of the moveable element, where the end surface of the moveable element has a taper complementary to that of the tapered end of the projection. The valve assembly is normally in the closed condition, and can be operated to be in an open condition by causing the moveable element to move towards the inlet. In the closed condition, the moveable element is positioned so that a sealing element, which in a preferred embodiment is coupled to the moveable element, blocks water under pressure from flowing from the inlet, through the handle portion and into the spray head portion, and out a spray nozzle of the spray head portion. The valve assembly is operated to switch from the closed condition to the open condition by pressing upon the trigger element, which causes the trigger element to move, from an initial position, linearly in the direction of the spray head. When the trigger element is pressed, the tapered end of the projection moves against the opposing end surface of the moveable element, which causes a force in the direction of the inlet to be applied to the end surface of the moveable element. The force on the end surface, in turn, causes the moveable element to move toward the inlet, such that the moveable element moves to a position at which the sealing element does not block the flow of water from the handle portion to the spray head portion. When the trigger element no longer is pressed, the trigger element returns to the initial position, such that the sealing element blocks the flow of water to the spray head portion and the assembly switches from the open condition to the closed condition.

The assembly may contain a trigger element that comprises a button cap that is depressed to turn the water flow on. Alternatively the trigger assembly may contain two separate button caps. The two button caps are independently operable and are configured so that each button allows a different flow of water from the handle portion to the spray head portion. Preferably, one button switches the valve assembly from the closed condition to the open condition, and the other button switches the valve assembly from the closed condition to a partially open condition.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1A is a partially segmented view of a hand operated spray valve assembly shown in the closed position in accordance with the invention.

FIG. 1B is an enlarged segmented view of the trigger portion of the assembly of FIG. 1A.

FIG. 1C is an enlarged segmented view of the assembly of FIG. 1A at the piston o-ring.

FIG. 2 is an exploded view of the assembly of FIG. 1A.

FIG. 3A is a partially segmented view of the valve assembly of FIG. 1A shown in an open position in accordance with the invention.

FIG. 3B is an enlarged segmented view of the trigger portion of the assembly of FIG. 3A.

FIG. 3C is an enlarged segmented view of the assembly of FIG. 3A at the piston o-ring.

FIGS. 4A and 4B are segmented views of alternative embodiments of the inventive assembly in the closed position at the piston o-ring.

### DETAILED DESCRIPTION OF THE INVENTION

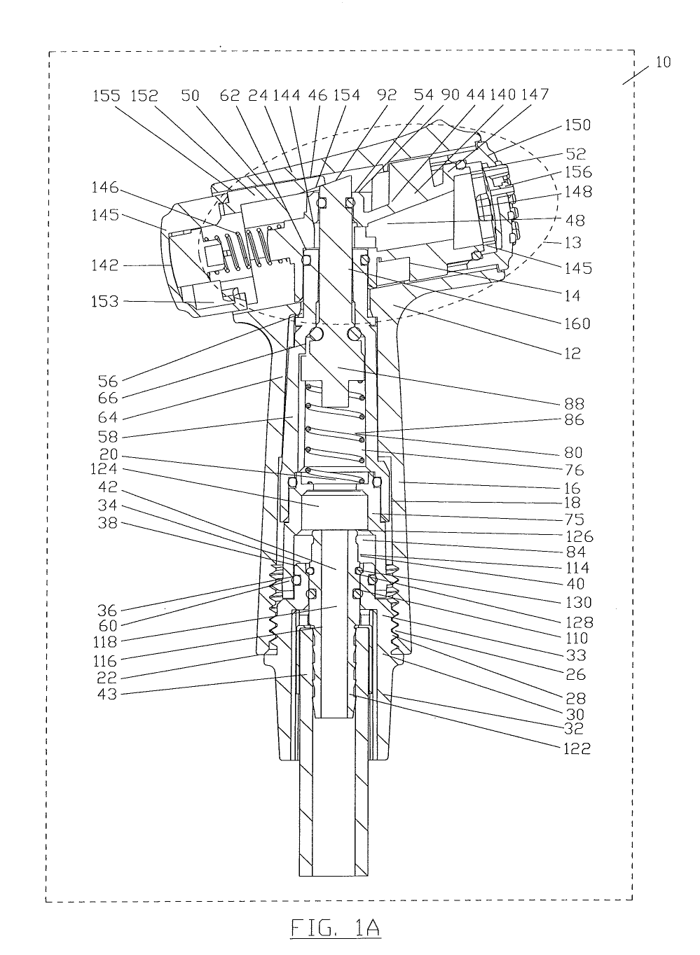

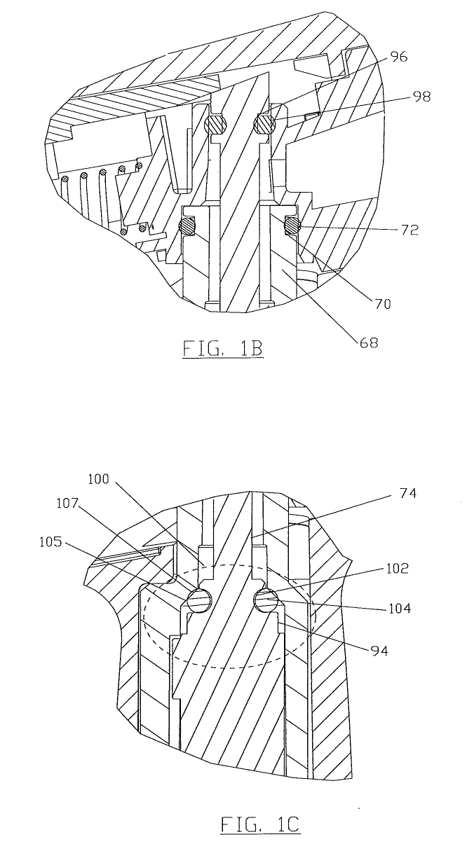

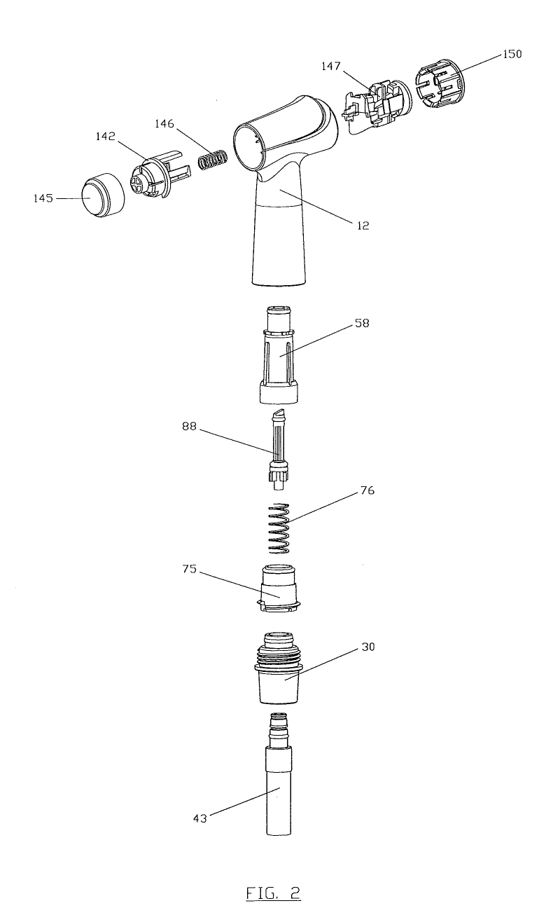

Referring to FIGS. 1A, 1B, 1C and 2, a spray valve assembly 10 includes a handle housing 12 connected to and preferably integral with, a spray head housing 14. The handle housing 12 includes a cylindrically-shaped wall 16 having an inner surface 18 that defines a chamber 20. The chamber 20 extends between an inlet end 22 and a spray head end 24. The inner surface 18 at the inlet end 22 includes threads 26. The threads 26 are sized to be threadably engageable to complementary threads 28 of a hose fitting 30. The hose fitting 30 includes a cylindrically-shaped barrel end 32 extending away from a body portion 33 of the fitting 30 including the threads 28. A circumferential recess 34 is defined in outer surface 36 of the fitting 30, and a sealing element 38, which is an O-ring in the exemplary embodiment illustrated in the drawings, is disposed in the recess 34. The outer surface 36 at the barrel end 32 of the fitting 30 has a smaller diameter than the outer surface 36 at the body portion 33 of the fitting 30. The body portion 33 and barrel end 32 of the fitting 30 further include an inner surface 40 that defines a chamber 42. The diameter of the inner surface 40 at the body portion 33 is substantially the same as the diameter of the outer surface of a conventional hose 43 that would be received within the chamber 42 and coupled to the fitting 30. The diameter of the inner surface 40 at the barrel end 32 is less than the diameter of the inner surface 40 at the body portion 33.

The spray head housing 14 includes a cylindrically-shaped wall 44 having an inner surface 46 that defines a chamber 48. The chamber 48 extends between a trigger end 50 and a spray face end 52. The wall 44 includes a top wall 54 opposing the end 24 of the handle housing 12, and defines an aperture 56 aligned with the end 24. As discussed below, the unoccupied portion of the chamber 20 can be placed in communication with an unoccupied portion the chamber 48 via the aperture 56 by operation of the assembly 10.

The chamber 20 of the handle housing 12 further includes a cylindrically-shaped waterway element 58 extending between a hose end 60 and spray head end 62. The waterway element 58 has outer and inner surfaces 64, 66. The hose end 60 of the waterway element 58 is fitted snugly between a portion of the barrel end 32 of the hose fitting 30 including the O-ring 38 and the inner surface 18 of the housing 12, such that the O-ring 38 forms a watertight seal between the waterway element 58 and the hose fitting 30. The waterway element 58 includes a body portion 68 extending from the hose end 60 to the spray end 62. The spray end 62 extends through the aperture 56 and into the chamber 48 of the spray head housing 14. The outer surface 66 at the spray end 62 of the waterway element 58 has a smaller diameter than the diameter of the outer surface 66 at the body portion 68, and includes a circumferentially-shaped recess 70 in which is disposed a sealing element 72 that is an O-ring.

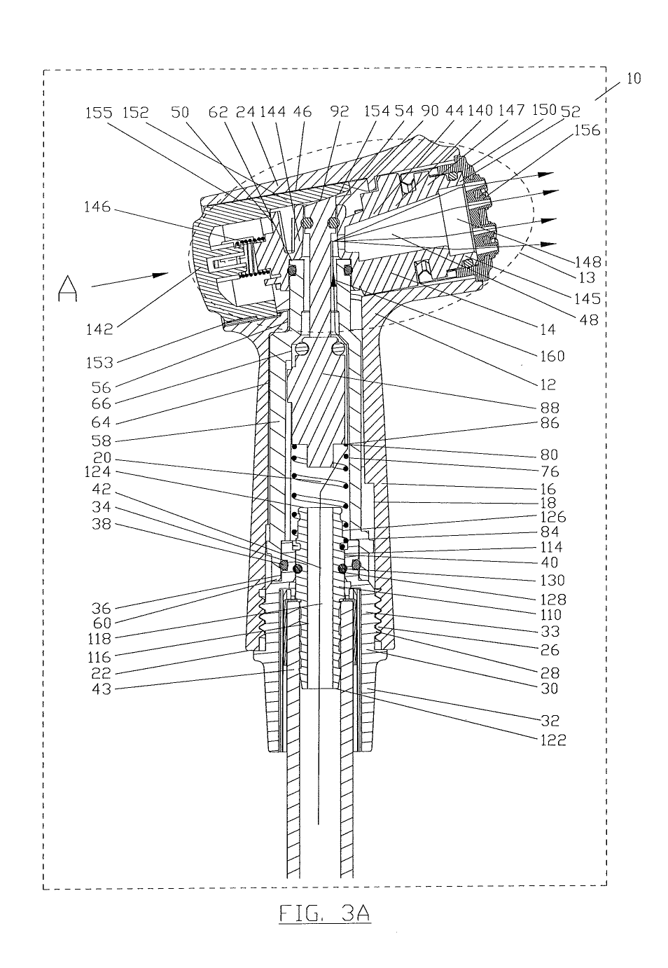

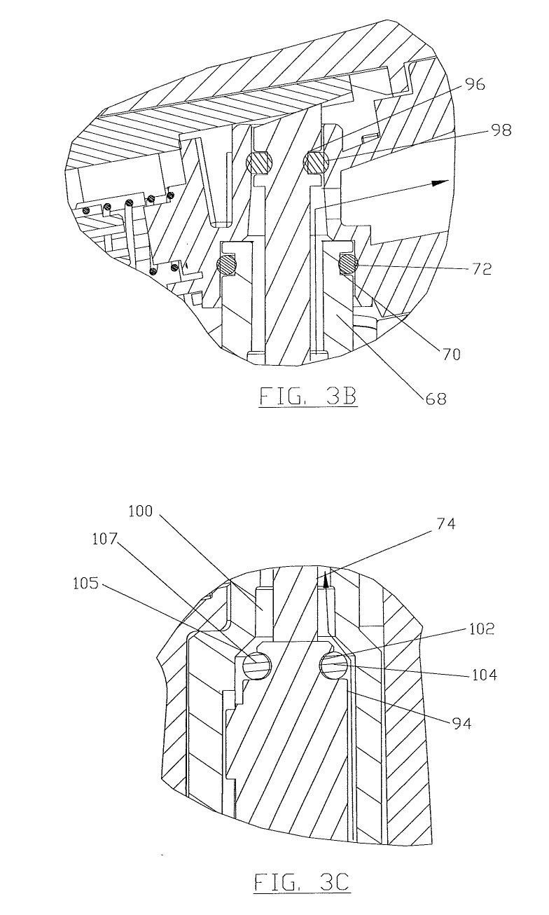

The waterway element 58 encircles a piston assembly 74. The piston assembly 74 includes a coil-shaped spring 76 extending between ends 80 and 84, where the end 80 is secured to an end 86 of a piston 88. The piston 88 extends from the end 86 toward the end 24 of the handle housing 12, into the chamber 48 and terminates at an end 90 opposite the top wall 54 of the spray head housing 14. The end 90 includes an end surface 92. Outer surface 94 of the piston 88 adjacent to the end 90 of the piston 88 includes a circumferentially-shaped recess 96 in which a sealing element 98 that is an O-ring is disposed. The piston 88 further includes a sealing section 100 disposed in the vicinity of the spray head end 24 of the chamber 20. The outer surface 94 at the sealing section 100 includes a circumferentially-shaped recess 102 in which is disposed a sealing element 104 that is an O-ring 104. The portion of the inner surface 66 of the waterway element 58 opposing the sealing section 100 is configured to provide that the valve assembly 10 is normally in a closed condition, and that movement of the piston 88 toward the inlet end 22, as discussed in detail below, causes the O-ring 104 to be positioned such that the assembly 10 switches from the closed condition to an open condition. The operation of the assembly 10 to switch from the closed condition to the open condition, and then back to the closed condition, is discussed in detail below. The closed condition of the assembly 10 is shown FIGS. 1A, 1B and 1C, and the open condition of the assembly 10 is shown in FIGS. 3A, 3B and 3C. Referring to FIGS. 1B and 1C, in the closed condition of the assembly 10 the O-ring 104 is tightly fit between the opposing inner surface 66 of the waterway element 58 and the outer surface 94 of the piston 88 at the sealing section 100 so as to create a watertight seal between the former and latter.

Referring to FIGS. 1A and 2, a hose connector 110 interconnects the conventional kitchen sink hose 43 to the assembly 10. The hose connector 110 is cylindrical in shape and includes an outer surface 114 and an inner surface 116. The inner surface 116 defines a chamber 118 extending between a hose end 122 and a piston end 124. The diameter of the outer surface 114 is substantially the same as the outer diameter of the hose 43. The piston end 124 extends into the chamber 20 through the end 32 of the hose fitting 30 and terminates at a point spaced from the end 86 of the piston 88. The outer surface 114 of the piston end 124 includes grooves 126 in which the end 84 of the spring 76 is disposed. The end 84 of the spring 76 is secured between the inner surface 40 at the end 32 of the hose fitting 30 and the outer surface 114 of the piston end 124 of the connector 110. The spring 76 and piston may be secured or held in place by a retainer ring 75. The piston end 124 of the hose connector 110 includes a circumferentially-shaped recess 128 in which is disposed a sealing element 130 that is an O-ring. The O-ring 130 is tightly fit between the opposing inner surface 40 of the hose fitting 30 and the piston end 124 to create a watertight seal the former and latter.

The spray head assembly 13 includes a spray portion 140 and a barrel 143. The barrel 143 tightly encircles a portion of the end 90 of the piston 88 including the O-ring 98, such that the O-ring 98 creates a watertight seal between the opposing surface of the barrel 143 and the piston 88. The barrel 143 also tightly encircles a portion of the end 62 of the waterway element 58 including the O-ring 72, such that the O-ring 72 creates a watertight seal between the opposing surface of the barrel 143 and the waterway element 58. The barrel 143 further includes a cylindrically-shaped body portion 147 extending toward the end 52 of the spray head assembly 13 and which defines a spray chamber 148. At the end 52, a spray face 150 is connected to the body portion 147 and the spray head assembly 13, so as to cover the spray chamber 148 at the end 52.

Further, the spray portion 140 includes a trigger 142 having a base surface 144. In an alternate embodiment (as best illustrated in FIG. 2), a button cap 145 is attached to the trigger 142. The button cap 145 is a separate piece attached or secured to the trigger 142 and can be colored or electro-plated. The button cap 145 is depressed causing compression of the spring 146 as described below. In yet another embodiment, the trigger 142 has two separate and independently operable button caps (not shown). In the two button embodiment, depression of the different buttons compress spring 146 to different degrees resulting in different flows.

The spray portion 140 includes a slider 152, which preferably is integral with the trigger 142 and has upper and lower outer surfaces 153 and 155. The slider 152 extends from the outer diameter portion of the base surface 144 (or the button cap 145 where used), along the surface 46 of the top wall 54 where the outer surface 153 contacts the surface 46, to a point above and opposing the piston end 90. An end surface portion 154 of the slider 152 extends from the outer surface 155 and tapers in the direction toward the outer surface 153. The angle of the taper of the end surface portion 154 in relation to the outer surface 155 is preferably about 20 to 33 degrees. In addition, the end surface 92 of the piston 88 has a taper that is complementary to the taper of the end surface portion 154. The end surface portion 154 of the slider 152 is positioned so that that the end portion 154 always is in contact with the piston end surface 92 and maintains a space between the piston end 90 and the top wall 54. In addition, a coiled spring 146 is secured to the base surface 144 at one end, and the other end of the spring 146 is secured to the portion of the barrel 143 facing the end 50 of the spray head housing 14.

Referring to FIGS. 1A, 1B and 1C, between the end 80 of the piston 88 and a point adjacent to the O-ring 98 and on the side of the O-ring 98 opposite to the wall 54, the inner surface 66 of the waterway element 58 and the outer surface 94 of the piston 88 define a water channel 160. The portion of the water channel 160 within the spray head portion is always in communication with the chamber 148. The position of the end 90 of the piston 88 in relation to the wall 54, however, determines whether the chamber 148, via the channel 160, is in communication with the chamber 20, such that water under pressure in the hose 43 can flow through the chamber 20, the channel 160, into the chamber 148 and then out of the chamber 148 through the spray face 150.

Operation of the assembly is now described with reference to FIGS. 1A, 1B, 1C, 3A, 3B and 3C. Referring to FIGS. 1A, 1B and 1C, in the normally closed condition of the valve assembly 10, at the sealing section 100 the O-ring 104 is tightly fit between the opposing inner surface 66 of the waterway element 58 and the outer surface 94 of the piston 88 to create a watertight seal in the channel 160. The watertight seal in the channel 160 obstructs the channel 160, thereby preventing water from the hose 43 from flowing through the hose fitting 30, the open portions of the chamber 20, through the entirety of the waterway channel 160, in other words, past the sealing section 100, and into the flow chamber 148.

Referring to FIGS. 3A, 3B and 3C, to cause the assembly 10 to switch from the closed condition to the open condition, a user pushes the trigger 142 (or button cap 145 when used), in the direction of arrow A, toward the spray face 150. The force on the trigger 142 (or button cap 145) compresses the spring 146 against the barrel 143, and causes the end surface 154 of the slider 152, which is integral with the trigger 142, to move linearly in the direction of the spray face 150. As the slider 152 moves toward the spray face 150, the end surface 154 moves against and linearly along the end surface 92 of the piston 88. The movement of the end surface 154 linearly against the complementarily angled end surface 92 causes a force to be applied on the piston 88 in the direction of the inlet end 22. Upon application of a sufficient force on the piston 88 in the direction of the inlet end 22, the spring 76 begins to compress and the piston 88 begins to move toward the end 22 of the handle housing 12.

In accordance with the present invention, the complimentarily angled and contacting opposing end surfaces 154 and 92 provide a mechanical advantage, such that a minimal amount of force needs to be applied to the trigger 142 to cause the trigger 142 to move linearly toward the spray face 150 and, in turn, cause the piston 88 to move towards the inlet end 22. The angle of the end surface 154 in relation to the outer surface 154 preferably is maintained small to reduce the amount of force that must be applied to the trigger 142 to cause the piston 88 to move away from the wall 54 and towards the inlet end 22. When the piston 88 is moved away from the wall 54 towards the end 22, the O-ring 104 also moves towards the end 22, such that the watertight seal created by the O-ring 104 in the channel 160 is broken. In other words, based on the movement of the piston 88 toward the end 22, the O-ring 104 no longer obstructs the water channel 160 and water can flow from the chamber 20, through the water channel 160 and to the chamber 148 and out of the spray face 150. Water will flow out of the spray face 150 so long as the user applies a sufficient force on the trigger 142, in the direction of the spray face 150, to cause the piston 88 to move to a position where the watertight seal at the O-ring 104 is broken.

When the assembly 10 is in the open condition and the user releases the trigger 142, the spring 146 causes the trigger 142, and thus the end surface 154, to move in the direction away from the barrel 143 and toward the end 50. As the trigger 142 moves away from the barrel 143, the spring 76, in turn, forces the piston 88 in the direction of the top wall 54. The piston 88 moves towards the top wall 54 until the O-ring 104 becomes tightly fit between the inner surfaces 66 and 94, which prevents further motion of the piston 88 towards the top wall 54. At this point, the O-ring 104 creates a watertight seal between the surfaces 66 and 94 within the sealing section 100, which prevents water from continuing to flow through the water channel 160 into the flow chamber 148 and out the spray face 150.

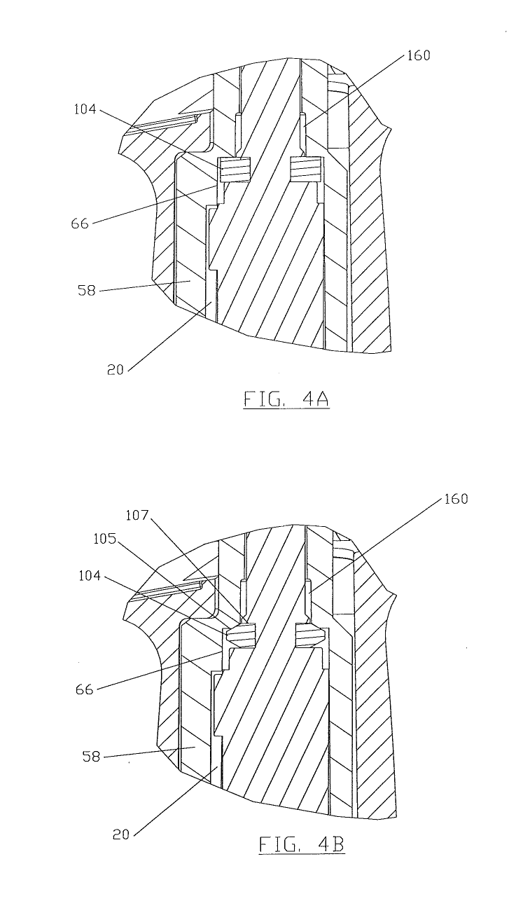

Referring to FIG. 4A, in one embodiment the sealing element 104 is rectangular or square in shape. Referring to FIG. 4B, in another embodiment, the sealing element 104 is substantially rectangular or square in shape and includes a surface 105 that faces the portion of the water channel 160 extending from the chamber 20. The surface 105 is tapered at an angle of about 45 degrees from surface 107 of the element 104 which contacts the opposing inner surface 66 of the waterway element 58.

In one embodiment, the spray face 150 is formed from a hard plastic material and the spray nozzle 156 is formed from rubber material. In another embodiment, the spray face 150 and the spray nozzle 156 are integral with each other and formed from a hard, plastic material.

In still another embodiment, the piston 88 is formed from a hard plastic material and the sealing element 104 is formed from a rubber material. In a further embodiment, the piston 88 and the sealing element 104 are integrated by molding.

Although preferred embodiments of the present invention have been described and illustrated, it will be apparent to those skilled in the art that various modifications may be made without departing from the principles of the invention.

What is claimed is:

1. A spray valve assembly comprising:
a housing having a handle portion and a spray head portion, wherein the handle portion includes a moveable element and a sealing element, wherein the moveable element extends between a first end opposing an inlet and a second end within the spray head portion, wherein the second end includes an end surface and wherein the moveable element is moveable toward the inlet when a force in the direction of the inlet is applied at the end surface;
wherein the spray head portion includes a trigger element on one end and a spray head on an opposing end, wherein the trigger element includes a projection extending toward the spray head and terminating in a tapered end, wherein the tapered end is in contact with and opposes the end surface of the moveable element, the end surface of the moveable element having a taper complementary to that of the tapered end of the projection;
wherein the valve assembly has a normally closed condition and an open condition;
wherein in the closed condition the moveable element is positioned such that the sealing element blocks the flow of water from the handle portion to the spray head portion; and
wherein the valve assembly is switched from the closed condition to the open condition by application of a force to the trigger element to cause the tapered end of the projection to move against the opposing end surface of the moveable element, wherein the opposing movement creates a force in the direction of the inlet on the end surface causing the moveable element to move toward the inlet and not be positioned such that sealing element blocks the flow of water from the handle portion to the spray head portion.

2. The assembly of claim 1, wherein the moveable element includes a piston coupled to a spring and the sealing element is an O-ring.

3. The assembly of claim 1, wherein the sealing element is coupled to the moveable element.

4. The assembly of claim 1, wherein the taper of the tapered end is at an angle of between about 20 and 30 degrees with respect to a surface of the projection from which the tapered end extends.

5. The assembly of claim 1 further comprising:
a waterway element encircling the moveable element, wherein the waterway element and the moveable element define a waterway channel extending between the inlet end and the spray head portion, wherein the sealing element is disposed in the waterway channel and (i) creates a watertight seal in the channel when the moveable element is in an initial position; and (ii) permits flow of fluid from the inlet, through the waterway channel and to the spray head portion when a sufficient force is applied to the trigger to move the moveable element from the initial position

6. The assembly of claim 5, wherein the sealing element is coupled to the moveable element and (i) contacts an opposing surface of the waterway element when the assembly is in the closed condition, and (ii) is spaced from the opposing surface of the waterway element when the assembly is in the open condition.

7. The assembly of claim 1, wherein the trigger element is integral with the projection.

8. The assembly of claim 1, wherein the trigger element comprises a button cap.

9. The assembly of claim 1, wherein trigger comprises two independently operable buttons to wherein each button allows a different flow of water from the handle portion to the spray head portion.

10. The assembly of claim 9, wherein the one button switches the valve assembly from the closed condition to the open condition, and the other button switches the valve assembly from the closed condition to a partially open condition.
